(19) United States
(12) Patent Application Publication
(10) Pub. No.: US 2009/0287546 A1
(43) Pub. Date: Nov. 19, 2009

(54) SYSTEM AND METHOD FOR ORGANIZING HOTEL-RELATED DATA

(75) Inventors: Scott Gillespie, Solon, OH (US); Thomas K. Tomosky, Bolivar, PA (US)

Correspondence Address: HARNESS, DICKEY & PIERCE, P.L.C., P.O. BOX 828, BLOOMFIELD HILLS, MI, 48303, US

(73) Assignee: TRX, INC., Atlanta, GA (US)

(21) Appl. No.: 12/465,067

(22) Filed: May 13, 2009

Related U.S. Application Data
(60) Provisional application No. 61/128,067, filed on May 16, 2008.

(51) Int. Cl. G06Q 50/00; G06N 5/02; G06Q 10/00; G06F 17/30

(52) U.S. Cl. 705/10; 706/46; 707/5; 707/E17.017; 707/E17.018

(57) ABSTRACT

A method for grouping hotels for a travel entity may include identifying a plurality of hotels stayed at in the past by members of a travel entity, identifying a subset of hotels having a particular significance to the travel entity, each hotel being associated with a position indicator, clustering hotels in the subset of hotels using a clustering algorithm, where the position indicator for each hotel serves as the basis for calculating a geographical similarity measure for the clustering algorithm, identifying hotels not used by the travel entity but that are within the boundaries of the clusters, and optionally displaying a visual depiction of a cluster of hotels.

### CROSS-REFERENCE TO RELATED APPLICATIONS

This application claims the benefit of U.S. Provisional Application No. 61/128,067, filed on May 16, 2008. The entire disclosure of the above application is incorporated herein by reference.

### FIELD

The present disclosure relates to a system and method for organizing hotel-related data, and more particularly to a system and method for organizing and analyzing hotel-related data to facilitate negotiations and program management.

### BACKGROUND

Corporate travel programs spend significant sums of money on hotels. Analyzing data related to hotels is problematic for a number of reasons, one of which relates to creating appropriate peer sets. For example, a travel manager may wish to know how one hotel's rates compare to a peer set, or to what extent her corporate travelers are complying with the company's travel policies.

In order to perform useful analyses, an analyst would like to work with a set of hotels that are comparable. Traditional practice has been to group hotels using two dimensions: 1) by some form of quality rating, such as 3-stars or 4-stars, or service types, such as extended stay, resort, upper-upscale, etc., and 2) by some form of common geographic feature, such as all hotels in the Chicago or Manhattan areas.

Given the relatively small geographic markets (akin to neighborhoods) in which hotels typically compete, it would be useful to have a method for quickly identifying and grouping hotels together into more practical peer sets. Past approaches have used city names, zip or postal codes, with limited effect. One hotel may be right across the street from another, but if they are in different zip codes, they will not be placed into the same peer set. Alternatively, hotels at the opposite ends of a large-area zip code are much less likely to be competitors due to the great distance between them.

Further complications arise when trying to construct a peer set of hotels for the purposes of negotiating preferred rates between a hotel and a corporate buyer. Each corporate buyer will likely have a different demand pattern due to the variety of key locations and attractions that each corporation has in a given market. In Manhattan, Company A's travelers may have most of their business occurring near Park and 52^{nd}, while Company B's travelers may gravitate toward hotels near 47^{th} and Broadway.

It would be useful to have a quick and logical method for grouping hotels into company-specific peer sets. Once these peer sets are established, then key statistics can be organized for each peer set, and thereby provide more valuable insights for analysts of hotel-related data. This section provides background information related to the present disclosure which is not necessarily prior art.

### SUMMARY

In one form, the present disclosure provides a method for grouping hotels for a travel entity. The method may include identifying a plurality of hotels stayed at in the past by members of a travel entity, identifying a subset of hotels having a particular significance to the travel entity, each hotel being associated with a position indicator, clustering hotels in the subset of hotels using a clustering algorithm, where the position indicator for each hotel serves as a geographic similarity measure for the clustering algorithm, and optionally displaying a visual depiction of a cluster of hotels.

In another form, the present disclosure provides a method that may include identifying a plurality of hotels having a particular significance to a travel entity, each hotel being associated with a position indicator, clustering hotels in the plurality of hotels using a clustering algorithm, where the position indicator for each hotel serves as the basis for calculating a distance measure for the clustering algorithm, for a given cluster, defining a geographic area that includes hotels within the given cluster, determining hotels within the geographic area including one or more hotels exclusive from the plurality of hotels, and visually depicting the hotels with the geographic area.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a block diagram depicting a system for organizing and analyzing hotel-related data according to the principles of the present invention;

FIG. 2 is a flowchart depicting a method for organizing and analyzing hotel-related data according to the principles of the present invention;

FIG. 3 is a flowchart depicting a method of grouping hotels according to the principles of the present disclosure;

FIG. 4 is a table illustrating an exemplary calculation of centroids according to the principles of the present disclosure;

FIG. 5 is a schematic representation of a map including the centroids of FIG. 4; and

FIG. 6 is a schematic representation of an exemplary embodiment of a map displaying the organization and analysis of the hotel related data according to the principles of the present disclosure.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

Example embodiments will now be described more fully with reference to the accompanying drawings.

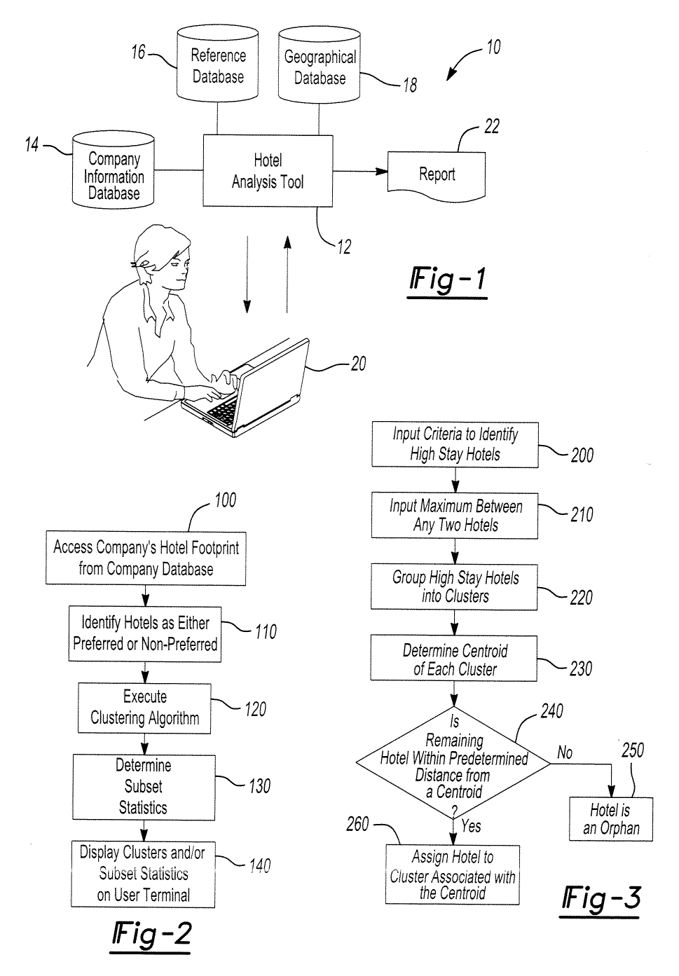

With reference to FIG. 1, a system for organizing and analyzing hotel-related data is provided and is generally referred to as the system 10. The system 10 may include a hotel analysis tool 12, a company information database 14, a reference database 16, a geographical database 18, and a user terminal 20. The system 10 may generate and display a report 22 that may be displayed on the user terminal 20 or any other electronic display device. The report 22 may be generated and/or displayed on Excel® or PowerPoint®, for example, or any other suitable program or interface. The report 22 may include hotel-related data, statistics and/or analysis that may allow a company to monitor its employees' travel trends, identify cost-savings opportunities and/or facilitate rate negotiations with one or more hotels, as will be subsequently described.

The hotel analysis tool 12 may be in communication with the company information database 14, the reference database 16, the geographical database 18, and the user terminal 20. The hotel analysis tool 12 may be a software program (i.e., computer executable instructions) installed on the user terminal 20, for example, and may be executable thereon. Alternatively, the hotel analysis tool 12 could be remote and/or operate independently of the user terminal 20, such as via an Internet service, for example. As used herein, the term “hotel analysis tool” may refer to, be part of, or include a server connected to the Internet, an Application Specific Integrated Circuit (ASIC), an electronic circuit, a processor (shared, dedicated or group) and/or memory (shared, dedicated or group) that execute one or more software or firmware programs, a combinational logic circuit and/or other suitable components that provide the described functionality.

The company information database 14 may include information about a company's travel history such as a list of preferred and non-preferred hotels, past, current and/or future hotel booking and/or spending patterns, for example. Throughout the present application, such information may be referred to as the company's travel footprint. The company's travel footprint may also include the number of room-nights that the company has booked at each hotel at which at least one of the company's travelers has stayed in the past and/or the amount of money spent at each hotel at which at least one of the company's travelers has stayed in the past. Additionally, the company information database 14 may store information about non-hotel destinations, such as locations of corporate offices, plants, distribution centers, and/or key customer locations, for example. Such information may include addresses, geographical coordinates, contact information, frequency of visits to the location and/or other measures of importance or significance to the company.

The reference database 16 includes information about a plurality of hotel properties. The plurality of hotels may include some or all of the hotels in cities, states, provinces, countries or regions of the world. The information about each of the plurality of hotels that may be stored in the reference database 16 may include (1) the property name, address, phone number and/or other contact information, (2) geographical coordinates of the property, i.e., latitude, longitude, and an elevational coordinate, if applicable (e.g., where multiple hotels occupy different floors of a single building), (3) the property's quality rating (e.g., four stars, diamonds, etc.) and/or service level (e.g., economy class, business class, upscale, etc.), (4) the property's chain code, franchise or parent company (e.g., Marriott® or Hilton®, etc.), (5) the property's brand affiliation (e.g., Courtyard Marriot®, Holiday Inn Express®, etc.), (6) the property's booking code, such that one may use a GDS (Global Distribution System) to find the hotel rates and property offers, (7) the property's room count, i.e., the number of rooms that the property has available for sale, (8) a list of amenities and accommodations that the property offers its guests, and/or (9) a list of promotional events or programs, such as rewards programs or group rates, for example, or any other information about the hotel properties. Such information may be obtained from a third party provider, such as a travel agent or Internet sources, or it may be compiled by the user or other agent of the company, for example.

The geographical database 18 may include data to generate local, regional, national and/or global maps and/or satellite images. Such data may be obtained from sources such as Google®, Yahoo!®, or MapQuest®, for example, or other websites or map sources. The databases 14, 16, 18 may be stored in one or more memory devices in communication with the hotel analysis tool 12.

The user terminal 20 may be a computer, such as a desktop or laptop, PDA (personal digital assistant), or a cellular phone such as a Blackberry® or iPhone®, for example. The user terminal 20 may be in communication with the hotel analysis tool 12 to allow the user to view or input data into the company information database 14, the reference database 16, the geographical database 18, and/or to view the report 22. In an embodiment where one or more of the databases 14, 16, 18 are stored on an Internet server, the user terminal 20 may include hardware and software to facilitate Internet connectivity.

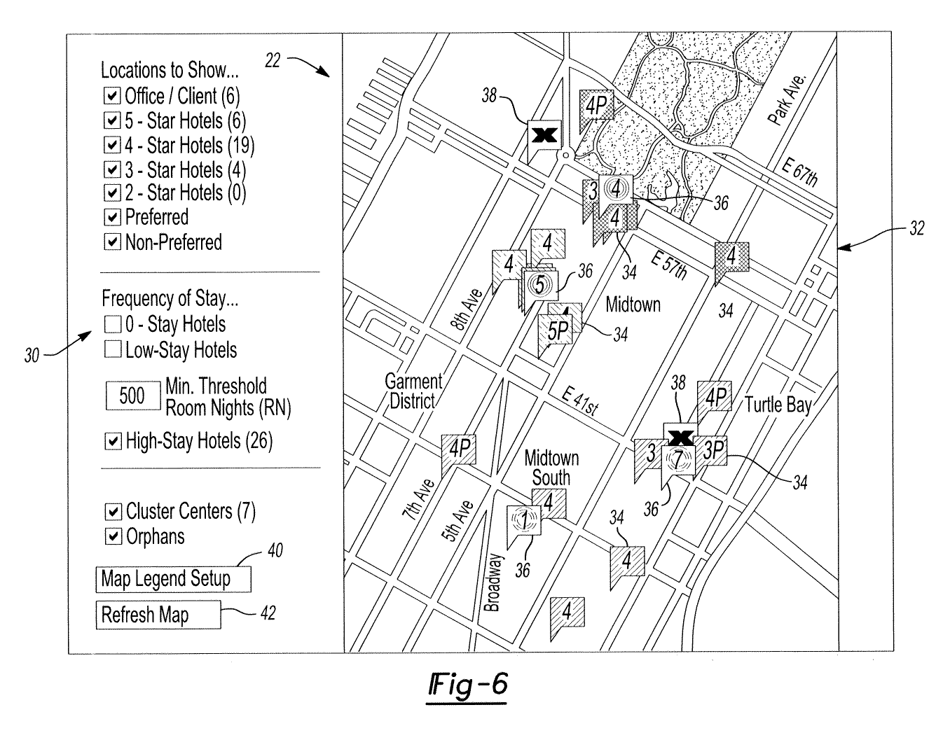

Referring now to FIG. 6, an embodiment of the report 22 is provided. The report 22 may be displayed on the user terminal 20 or any other computer or display device. The report 22 may include a plurality of customization tools 30 and a map 32 of a particular area of interest. The map may be generated from data obtained from the geographical database 18. The map 32 may include one or more groups or clusters of icons 34, 36, 38 representing groups or clusters of hotel properties and/or other locations of interest. Colors (represented in FIG. 6 by cross-hatch patterns), symbols, numbers and/or letters on the icons 34 may represent statistical data about the corresponding hotel property, as will be subsequently described.

With reference to FIGS. 1-6, operation of the system 10 and the method of organizing and analyzing the hotel-related data will be described in detail. The method may group hotels for a company or other travel entity. The system 10 may then produce statistics for each of the hotels and display the hotels and statistics in a manner that may allow a company to negotiate better hotel rates and/or monitor its travelers travel practices or patterns. It is also envisioned that system may be used by hotels to better understand corporate purchasing behavior.

With particular reference to FIG. 2, an embodiment of the method for grouping hotels for a travel entity is illustrated. At block 100, a user, such as a corporate buyer, procurement manager, travel agent, or business analyst, for example, may access data about the company's hotel footprint from the company information database 14 via the user terminal 20. As described above, the company's hotel footprint may include data about the company's hotel booking and/or spending patterns. In particular, accessing the hotel footprint may include identifying the hotels at which one or more of the company's employees, owners or other representatives have stayed in the past. For each of the identified hotels, the user may input or access the total of the room-nights booked and/or the total amount spent (e.g., in dollars, euros, yen, or other currency) at the hotel. The user may input or confirm a quality rating, using a standard rating system such as number of stars or service level type or a custom or company-specific internal rating system indicating employee feedback, for example, for some or all of the identified hotels. The user may also access each of the hotel properties' geographical locations (i.e., a position indicator such as latitude and longitude coordinates). The quality rating and geographical locations of the hotels may be obtained from the reference database 16, as described above, or they may be determined independently by the user or a third party.

Optionally, the user may input or access a list of significant non-hotel destinations including corporate offices, plants, distribution centers, key customer locations, and/or key supplier locations, for example, that may further define the travel and lodging patterns of the company's travelers. As will be subsequently described, the system 10 may use these significant non-hotel destinations to refine or influence the hotel grouping.

At block 110, the user may identify each hotel as a preferred hotel or a non-preferred hotel and input the appropriate designation into the company information database 14. It should be appreciated that this step may be performed automatically by the hotel analysis tool 12. The preferred hotels may be hotels with which the company has negotiated a special rate or discount for a predetermined number of room-nights per year, for example, and the company may urge its travelers to stay these hotels. The non-preferred hotels may be hotels at which no such special rate or discount has been agreed upon, and therefore, the company may expect its travelers to avoid these hotels, if practical. The user may input or access the special rate or discount associated with each preferred hotel into the company information database 14.

At block 120, the hotel analysis tool 12 may execute a clustering algorithm to group the hotels based on information stored in the company information database 14, the reference database 16 and/or the geographical database 18. The clustering algorithm may group the hotels in the company's hotel footprint into groups or clusters based at least partially upon the hotels' geographic locations, as will be subsequently described. With the hotels grouped into clusters, the hotel analysis tool 12 may determine one or more subset statistics, as shown at block 130. Such statistics may be useful for negotiating special or preferred rates at one or more hotels.

At block 140, the hotel analysis tool 12 may generate the report 22 (FIGS. 1 and 6), which may include a visual representation of the hotels, the hotel clusters and/or subset statistics. The visual representation may include the map 32 having the hotels plotted thereon, as shown in FIG. 6, and may be displayed on the user terminal 20 or any other display device.

Referring now to FIG. 3, the clustering algorithm will be described in detail. At block 200, the user may input, via the user terminal 20, criteria to identify hotels of interest (or lead hotels). The hotels of interest may be the preferred hotels and/or High Stay hotels. High Stay hotels may be the hotels with which the company has a significant amount of business. The criteria for a hotel to be a High Stay hotel may include a threshold of money spent at the hotel or a threshold number of room-nights booked at the hotel. The user may customize this threshold. In the particular example illustrated in FIG. 6, the threshold for identifying High Stay hotels has been set to 500 room-nights. It should be appreciated that this criteria can be set to any value that the user deems appropriate and may represent, for example, 10% of all room-nights booked by the company, or any other percentage. Whether a particular hotel is a High Stay hotel may be an importance indicator or factor of weight associated with the particular hotel.

While the High Stay importance indicator may be binary (i.e., the hotel is High Stay if it is at or above the predetermined threshold), the High Stay importance indicator could be on a scale of weighting factors. For example, if a hotel has been booked for over 100 room-nights, it could be assigned an importance indicator five time greater than hotels with less than 100 room-nights. For every 500 room-nights beyond 100 room-nights, the importance indicator may increase by a factor of five, for example.

At block 210, the user may optionally establish a predetermined maximum distance between hotels in each cluster, such that no two hotels in a given cluster are farther apart than the predetermined maximum distance. The user may input and/or customize the predetermined maximum distance via the user terminal 20. Additionally or alternatively, the user may group the hotels of the company's hotel footprint into common geographic units such as states, provinces, countries, or other easily identifiable and relatively large geographic units. This may improve the performance of the clustering algorithm.

Prior to clustering the hotels of interest, the hotel information from the company information database may need to be normalized (i.e., placed in a standardized format) and/or matched to records in the reference database. For example, the company information database may not include the geographic location (e.g., lat/long coordinates) for each of the hotels of interest. Such information can be retrieved from the reference database before proceeding with clustering. As part of this data retrieval, how the company references a hotel (e.g., “Cincinnati Hilton”) needs to be linked or matched to the corresponding information (e.g., “Hilton Greater Cincinnati Airport”) in the reference database. Other types of data normalization and/or matching may also be needed.

The hotel analysis tool 12 may then group the hotels of interest into clusters as indicated at 220. Any of several suitable clustering approaches may be utilized, including hierarchical clustering, K-means clustering, or Gaussian mixture models, for example. One skilled in the field of cluster analysis can be employed to assist in selecting the optimum approach. The hotel analysis tool 12 may include any suitable math or statistics software application having a cluster analysis module, such as MATLAB®, software by SAS® or SPSS®, for example, or any other software application suited to cluster the hotels.

Hierarchical clustering groups data into a cluster tree or dendrogram. The cluster tree may be a multilevel hierarchy. Clusters at a first level of the cluster tree may be joined as clusters at a higher level. The user may select the level or scale of clustering that is appropriate for the desired analysis. The cluster analysis software may plot the cluster tree.

K-means clustering divides data into mutually exclusive clusters based on actual observations rather than dissimilarity measures. K-means clustering may be preferred over hierarchical clustering for analyzing large amounts of data. The software may partition the data such that hotels within each cluster are as close to each other as possible and as far as possible from hotels in other clusters.

Gaussian mixture models may form clusters based on a mixture of multivariate normal densities of observed variables. An expectation maximization (EM) algorithm may assign posterior probabilities to each component density with respect to each observed variable. The software may form clusters by selecting a hotel that maximizes a posterior probability. When the data includes clusters having different sizes and correlations, Gaussian mixture modeling may be more appropriate than k-means clustering.

As a result of running the cluster analysis on the hotels of interest, the hotels of interest are grouped into geographically similar clusters, without regard to a postal code, city, state, province, or county boundaries, or other artificial or man-made geographical boundaries. The hotel analysis tool 12 may be configured to limit the number of clusters that it groups the hotels into. For example, the number of clusters could be equal to half of the number of hotels in the company information database 14. It will be appreciated that there could be any other suitable number of clusters.

As shown at block 230, the hotel analysis tool 12 may determine a centroid of each cluster of hotels. The centroid of a particular cluster may be the geometric center of all of the hotels in that cluster. This centroid may be referred to as the un-weighted centroid. Additionally or alternatively, the hotel analysis tool 12 may determine a weighted centroid.

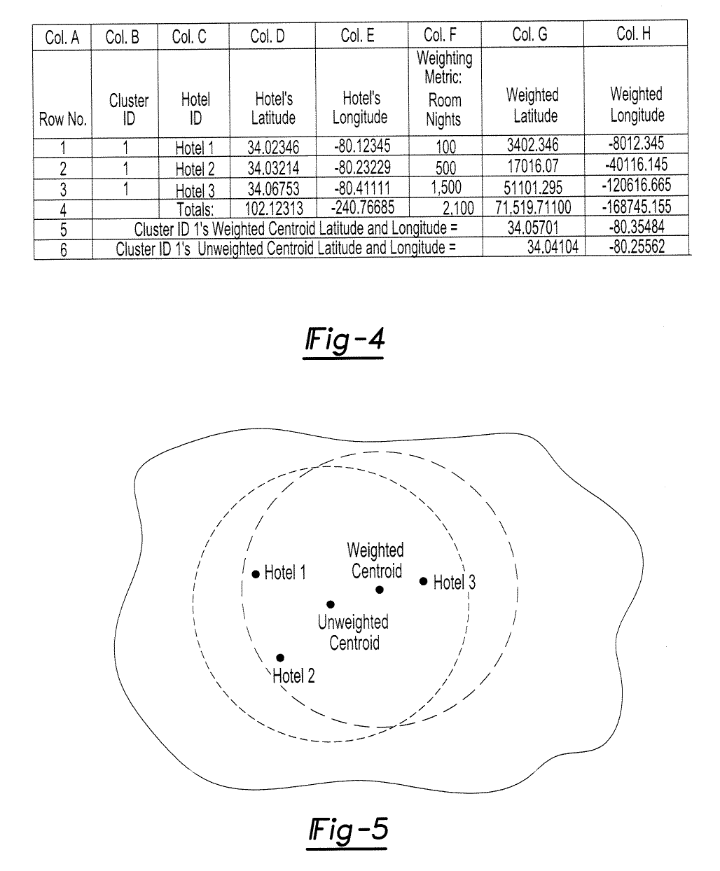

Referring now to FIGS. 4 and 5, a process for determining a particular cluster's weighted and/or un-weighted centroid will be described. First, the user may select and input a metric by which to weight the latitudes and longitudes of the hotels in the cluster. The metric may be room-nights booked at the hotel, total amount spent at the hotel, room capacity of the hotel, or any other importance measure or indicator. Alternatively, the metric or importance measure could be an indicator of proximity to important non-hotel destinations, such that the higher the numerical value of the weighting metric, the closer the corresponding hotel is to the important non-hotel destination. In the particular example illustrated, the weighting metric is the number of room-nights booked at each hotel.

Each hotel's latitude and longitude coordinates may then be multiplied by the weighting factor to produce each hotel's weighted latitude and weighted longitude (shown in FIG. 4 at Rows 1-3 of Columns G and H). For each hotel, the hotel analysis tool 12 calculates the sum of the un-weighted latitude coordinates, the sum of the un-weighted longitude coordinates, the sum of the weighting metrics, the sum of the weighted latitude coordinates and the sum of the weighted longitude coordinates. In other words, the hotel analysis tool 12 sums the values in each column from Column D to Column H. These totals are shown in Row 4, Columns D-H.

To calculate the coordinates of the weighted centroid (Row 5, Columns G and H), the sums of the weighted latitude coordinates (Row 4, Column G) and weighted longitude coordinates (Row 4, Column H) are both divided by the sum of the weighting metrics (Row 4, Column F). To calculate the coordinates of the un-weighted centroid (Row 6, Columns G and H), the sums of the un-weighted latitude coordinates (Row 4, Column D) and un-weighted longitude coordinates (Row 4, Column E) are both divided by the number of selected hotels in the cluster, which in this example, is three. As shown in FIG. 5, the weighted centroid is shifted from the un-weighted centroid toward the location of Hotel 3, since Hotel 3 was assigned the highest weighting metric. The above process may be repeated to find the weighted and/or un-weighted centroids for each cluster.

Referring again to FIG. 3, the hotel analysis tool 12 may determine whether to assign additional hotels to the clusters of hotels of interest. As shown at block 240, the hotel analysis tool 12 may determine whether each of the hotels that were not previously identified as hotels of interest (hereinafter referred to as non-lead hotels) are within a predetermined distance from each of the cluster centroids. The predetermined distance may be equal to the distance between the centroid and the furthest hotel of interest in the cluster from the centroid plus a percentage such as 20%, for example. Alternatively, the predetermined distance may be a constant value such as 1.5 miles, for example. As another alternative, the user may select a suitable distance as a program setting.

As shown at block 250, if the hotel analysis tool 12 determines that any of the non-lead hotels (stored in the company information database 14 and/or reference database 16) are not within the predetermined distance from a centroid, the hotel analysis tool 12 may determine that these hotels are to be considered orphans and not included in further processing. However, if the hotel analysis tool 12 determines that any of the non-lead hotels are within the predetermined distance from a centroid, the hotel analysis tool 12 may assign the non-lead hotel to the cluster associated with that centroid, as shown at block 260. If the non-lead hotel is within the predetermined distance from more than one centroid, then the hotel analysis tool 12 may assign the non-lead hotel to the cluster associated with the closest centroid.

Once the hotel analysis tool 12 establishes the clusters and identifies the hotels that are in each cluster, the user may choose to (or the hotel analysis tool 12 may automatically) filter or subdivide the hotels into subsets based on the quality rating, the preferred or non-preferred status, by frequency of stay and/or by whether they are lead or non-lead hotels, for example. The hotel analysis tool 12 may produce more useful statistics and/or analyses with the hotels subdivided into these subsets. For example, if the clusters are subdivided into subsets based on quality rating, the statistics and/or analyses may be more useful, as the hotels in each subset may be more comparable to each other. Subsets based on quality rating may make benchmarking, analysis, reporting and/or negotiation of rates more practical, since these subsets may more accurately represent local market competition. For example, the statistics and/or analyses for the clusters and/or subsets may include: (1) the total room-nights booked for each subset, which may be useful when hotels are bidding to become preferred hotels, (2) each subset's compliance percentage, (3) each hotel's fair market share, (4) each hotel's support ratio, (5) the hotel density for each subset, which may be found by counting the number of hotels in each subset, (6) hotel-specific distance metrics, (7) coverage, and/or (8) overlap. It will be appreciated that other useful statistics and/or analyses may be obtained from the clusters and/or subsets of hotels that may facilitate or be useful for negotiating hotel rates for the company, budgeting and/or cost-cutting analyses.

Each subset's compliance percentage may be found by dividing the sum of the cluster's total room-nights booked (or total amount spent) at the preferred hotels divided by the sum of the cluster's total room-nights booked (or total amount spent) at all of the hotels in the cluster. A high percentage indicates that the company's travelers strong tendency to stay at the company's preferred hotels within the cluster. This may be useful information in negotiations with potential preferred hotels, since the hotels will want a high compliance percentage when they agree to become a preferred hotel in exchange for a special rate or discount. This information may also enable the user to identify savings or savings opportunities associated with a high compliance percentage at preferred hotels. If the compliance percentage is low at one or more hotels, the company may save money by implementing travel policies requiring or strongly urging travelers to stay at the preferred hotels.

Each hotel's fair market share may be found by calculating each hotel's share of the cluster's total room capacity, or by weighting each hotel's share of the cluster's room capacity in proportion to the hotel's proximity to the cluster's centroid (weighted or un-weighted). The fair market share may indicate an expected share of the company's business each hotel could expect if all other factors that could potentially influence a traveler's choice were equal for each hotel in the cluster.

Each hotel's support ratio may be found by dividing the number of room-nights booked at the hotel by its fair market share of the cluster's bookings. A high support ratio indicates that the company's travelers have historically supported the hotel or chosen the hotel often. Whereas a low support ratio indicates some degree of avoidance of the hotel or that the company's travelers have historically avoided the hotel or chosen other hotels.

Each hotel's distance metrics may include a distance from the hotel to the important non-hotel destinations described above, a distance to the cluster centroid, distances to restaurants, entertainment venues, airports, and/or distances to other locations. These distance metrics may indicate the hotel's ability to attract more room-nights or earn a high support ratio and/or compliance percentage if it were a preferred hotel.

The “coverage” statistic, as the term is used above, may refer to the extent to which a hotel chain or brand may be able to cover or meet the company's booking volume (i.e., number of room-nights). To determine the coverage value for a particular chain or brand of hotels, the hotel analysis tool 12 may first sum the fair market share of each of the hotels in the cluster associated with the chain or brand. This value may then by multiplied by the entire cluster's volume metric (i.e., room-nights) to determine a coverage volume for the chain or brand. These steps may be repeated (or performed concurrently) for multiple clusters or all of the clusters. Then, the chain or brand's coverage volume for each cluster may be totaled and divided by the sum of each cluster's volume. The resulting percentage indicates the chain or brand's capacity to cover or meet the company's room-night booking volume. A high coverage percentage indicates that the chain or brand may have a high capacity to cover the company's booking volume.

The “overlap” statistic, as the term is used above, may indicate the extent to which a plurality of brands or chains overlap each other in a particular cluster in terms of fair market share. The user may select, via the user terminal 20, the chains or brands to be analyzed. To determine the overlap for the selected chains or brands within a particular cluster, the hotel analysis tool 12 may first determine the fair market share for each of the selected chains and identify the chain having the highest fair market share. Then, the fair market shares for the remaining chains may be summed. The lesser fair market share value between the chain having the highest fair market share and the total fair market share of the remaining chains is the overlap value.

To illustrate this concept with an example overlap calculation, suppose the user selects three chains: Hyatt, Hilton and Marriott. Suppose further that the fair market shares of these chains are 10%, 18% and 32%, respectively. In this example, the hotel analysis tool 12 will identify the Marriott chain as the chain having the highest fair market share (32%). The hotel analysis tool 12 will sum the fair market shares of the remaining chains (Hyatt and Hilton), which in this example, is 28%. The lesser fair market share value between the chain having the highest fair market share (Marriott at 32%) and the total fair market share of the remaining chains (Hyatt and Hilton at 28%), which in this example is 28%, is the overlap value.

One or more of the statistics described above may useful to the company in negotiating hotel rates and/or reducing the company's travel expenses. For example, the statistics may be used as leverage in negotiations with hotels to illustrate to the hotels the amount of business they may stand to gain or lose based on the decision of whether to grant the company a preferred status and/or a discounted rate and become a preferred hotel. As described above, the statistics may provide motivation or justification for implementing travel policies requiring or urging travelers to stay at certain hotels, such as preferred hotels, for example.

It should be appreciated that for purposes of clustering and generating cluster and/or subset statistics and/or analyses, non-hotel locations (offices, plants, client or supplier locations, etc.) may be treated the same as the hotel properties. Non-hotel locations can be assigned varying weighting metrics in correlation to their importance in drawing travelers to near-by hotels. Further, the user may select whether to display the non-hotel locations on the report 22 using the customization tools 30 (FIG. 6).

Referring now to FIG. 6, the report 22 may be displayed on the user terminal 20, for example, or any other suitable display device. As described above, the report 22 may include the map 32 including a plurality of hotel icons 34 each representing a hotel property. The hotel icons 34 may include different sizes, colors or cross-hatching patterns (as shown in FIG. 6) to indicate the hotel's association with a particular cluster. White or blank icons may indicate an orphan hotel, i.e., a hotel that is not associated with a cluster. The numbers overlaid on the hotel icons 34 may indicate the hotel's quality rating (e.g., 3-star, 4-star, etc.). The hotel icons 34 corresponding to preferred hotels may include the letter “P.” Although not specifically shown, the customization tool 30 may include an option allowing the user to display service levels (e.g., full service or limited service) and/or market tiers (e.g., economy, luxury, upscale, or upper-upscale).

The degree to which a particular hotel icon 34 is filled with color or cross-hatching may indicate that the company has booked a threshold number of room-nights at the hotel. For example, a completely filled icon 34 may indicate a High-Stay hotel, which in the example shown is 500 room-nights. A half-filled icon 34 may indicate a lower threshold of room-nights, and an icon 34 having only a border of color or cross-hatching may indicate that the company has never booked that particular hotel.

The physical size of each hotel icon 34 may correspond to the capacity or number of rooms available at the hotel. It should be appreciated, however, that the size of the icon 34 or extent to which the icon 34 is filled with color or cross-hatching may indicate other statistics or metrics such as amount of money spent at the hotel or the amount of savings lost or realized by booking or failing to book at the hotel.

Cluster centroids may be represented by icons 36, which may include concentric circles or “bull's-eye” markings. The numbers on the centroid icons 36 may identify the particular clusters. The line-type or color of the bull's-eye markings may indicate a statistical value for the associated cluster as determined by the hotel analysis tool 12. For example, a green bull's-eye may indicate 75-100% compliance in the associated cluster (i.e., the percentage of room-nights in preferred hotels out of the total number of room-nights in the cluster). A yellow bull's-eye may indicate that compliance is between 50 and 75%, and a red bull's-eye may indicate that compliance is less than 50%. The size of the centroid icon 36 may correlate to the number of room-nights booked at hotels in the cluster. However, the size of the centroid icon 36 could indicate other statistics or metrics such as the amount of savings lost or realized by booking or failing to book at the hotels in the cluster

Non-hotel locations may be represented by non-hotel icons 38. In the particular embodiment illustrated, the non-hotel icons 38 include X-marks, however, any other distinguishing symbol, shape or color may be used to represent the non-hotel locations.

It will be appreciated that the hotels, centroid, cluster, statistics, metrics and/or other information could be displayed in any suitable manner including any number of geographic modeling systems (e.g., 2-D, 3-D, heat maps, etc.), and therefore, the present disclosure is not limited to the symbols, icons and distinguishing features of such symbols and/or icons described above. The report 22 may include a Map Legend Setup button 40 that the user may select to change or confirm the meaning of the various distinguishing features of the icons 34, 36, 38. The user can select the Refresh Map button 42 to update the map upon making any changes with the customization tool 30 and/or Map Legend Setup button 40. Additionally or alternatively, the system 10 may be configured such that the user may click on (using a mouse or other pointing device, for example) the icons 34, 36, 38 which may open a separate report window to display metrics, statistics, and/or analyses about the associate hotel, cluster or subset.

Although the system 10 and method are described above as organizing and analyzing hotel-related data, it should be appreciated that the principles of the present disclosure are not limited to hotels and may be applicable to motels, bed and breakfast establishments, and/or other inns or lodging facilities. Further, the system 10 may be applicable to other locations and/or establishments of interest beyond the lodging and travel industries. For example, the system 10 may cluster restaurants, stores or vendors of office supplies, services and/or business solutions such as Kinko's®, Office Depot®, The UPS Store®, or the like, or any other location or establishment with which the company may conduct business. Further, while the system 10 and method are described above with reference to a company or business unit, it should be appreciated that the principles of the present disclosure are also applicable to other entities such as professional organizations, schools, clubs, teams, and/or any other association, organization or group that may procure, sponsor and/or negotiate travel accommodations for its members.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method for grouping hotels for a travel entity, comprising:
identifying a plurality of hotels stayed at in the past by members of a travel entity;
identifying a subset of hotels having a particular significance to the travel entity, each hotel being associated with a position indicator;
clustering hotels in the subset of hotels using a clustering algorithm implemented by one or more processors, where the position indicator for each hotel serves as a basis for a geographic similarity measure for the clustering algorithm; and
displaying on a display device a visual depiction of hotels in a given cluster resulting from the clustering algorithm.

2. The method of claim 1 further comprising analyzing hotels associated with the given cluster.

3. The method of claim 2 further comprises determining a statistic for the given cluster selected from a group consisting of a market share, a compliance percentage, a coverage percentage, a support ratio and an overlap.

4. The method of claim 1, wherein the step of identifying a subset of hotels having a particular significance to the travel entity includes identifying the subset of hotels as preferred hotels.

5. The method of claim 1, wherein the step of identifying a subset of hotels having a particular significance to the travel entity includes identifying the hotels at which members of the travel entity have stayed for a predetermined number of room-nights or have spent a minimum amount of money.

6. The method of claim 1, further comprising determining a centroid of the cluster of hotels based on the position indicators of the hotels.

7. The method of claim 1, further comprising determining a weighted centroid of the cluster of hotels based on the position indicators of the hotels and a weighting metric.

8. The method of claim 1, wherein the step of displaying a visual depiction of a cluster of hotels includes generating a map of a geographical area, plotting each of the hotels in the cluster of hotels on the map, and displaying the map and the hotels plotted thereon.

9. The method of claim 8, further comprising filtering the hotels plotted on the map according to a predetermined criterion.

10. The method of claim 9, wherein the predetermined criterion is a quality rating of the hotels.

11. A method for grouping hotels for a travel entity, comprising:
identifying a plurality of hotels having a particular significance to a travel entity, each hotel being associated with a position indicator;
clustering hotels in the plurality of hotels using a clustering algorithm implemented by one or more processors, where the position indicator for each hotel serves as a distance measure for the clustering algorithm;
for a given cluster, defining a geographic area that includes hotels within the given cluster;
determining hotels within the geographic area including one or more hotels exclusive from the plurality of hotels; and
visually depicting on a display device the hotels within the geographic area.

12. The method of claim 11 further comprising analyzing at least one of the hotels associated with the given cluster.

13. The method of claim 12 further comprises determining a statistic for the given cluster selected from a group consisting of a market share, a compliance percentage, a coverage percentage, a support ratio and an overlap.

14. The method of claim 11, wherein the step of identifying a plurality of hotels having a particular significance to a travel entity includes identifying the plurality of hotels as preferred hotels.

15. The method of claim 11, wherein the step of identifying a plurality of hotels having a particular significance to the travel entity includes identifying the hotels at which members of the travel entity have stayed for a predetermined number of room-nights.

16. The method of claim 11, further comprising determining a centroid of the cluster of hotels based on the position indicators of the plurality of hotels.

17. The method of claim 11, further comprising determining a weighted centroid of the cluster of hotels based on the position indicators of the hotels and a weighting metric.

18. The method of claim 11, wherein the step of visually depicting the hotels includes generating a map of the geographical area, plotting each of the hotels in the cluster of hotels on the map, and displaying the map and the hotels plotted thereon.

19. The method of claim 18, further comprising filtering the hotels plotted on the map according to a predetermined criterion.

20. The method of claim 19, wherein the predetermined criterion is a quality rating of the hotels.
